(19) United States
(12) Patent Application Publication
(10) Pub. No.: US 2003/0026661 A1
(43) Pub. Date: Feb. 6, 2003

(54) Method of cleaning contaminated soil

(76) Inventors: Harry Murphy, Oklahoma City, OK (US); James M. Murphy, Oklahoma City, OK (US)

Correspondence Address: DUNLAP, CODDING & ROGERS P.C., PO BOX 16370, OKLAHOMA CITY, OK, 73114, US

(21) Appl. No.: 09/920,398

(22) Filed: Aug. 1, 2001

(51) Int. Cl. B09C 1/08

(52) U.S. Cl. 405/128.75

(57) ABSTRACT

A method of reducing the contamination of soil in an area having varying degrees of contamination wherein the soils in locations having contaminations above a pre-determined level are first homogenized and then those soils are homogenized with the soil in the remainder of the area to be treated, whereupon the homogenized soils are treated until the contamination is reduced to a desired level.

### RELATED REFERENCES

Not applicable.

### FIELD OF THE INVENTION

This invention relates to method of cleaning contaminated soil, and more particularly, but not by way of limitation, to the treatment of contaminated soil collected from an area having varying degrees of contamination.

### BACKGROUND OF THE INVENTION

There are many techniques for reducing the contamination of soil from a relatively small area, such as the location of a fuel tank which may have been leaking into a rather confined area for many years. However, there has not been an effective and efficient technique for reducing the contamination of a relatively large area, such as 5 acres, where the level of contamination varies from location to location throughout the area under consideration.

In summary, the present invention involves a process of homogenizing contaminated soils from different parts of a site with different degrees of contamination of, for example, crude oil, petroleum distillates, pesticides, PCBs, or chemically similar compounds. Eliminating such chemical “hot spots” is an important first step in remediation of relatively large-area contamination, such as an abandoned refinery, abandoned or closed landfill, chemical production facilities or airports.

### BRIEF DESCRIPTION OF THE DRAWINGS

FIG. 1 is a side view of a machine utilized for homogenizing and treating soil pursuant to this invention.

FIG. 2 is an elevational view of the opposite side of the machine shown in FIG. 1.

FIG. 3 is a plan or top view of the machine shown in FIGS. 1 and 2.

FIG. 4 is a plan view of an area to illustrate varying levels of contamination in the area.

### DETAILED DESCRIPTION OF THE PREFERRED EMBODIMENT

The present invention makes use of a shredder-mixer disclosed in U.S. Pat. No. 4,978,079, the disclosure which is hereby incorporated by reference.

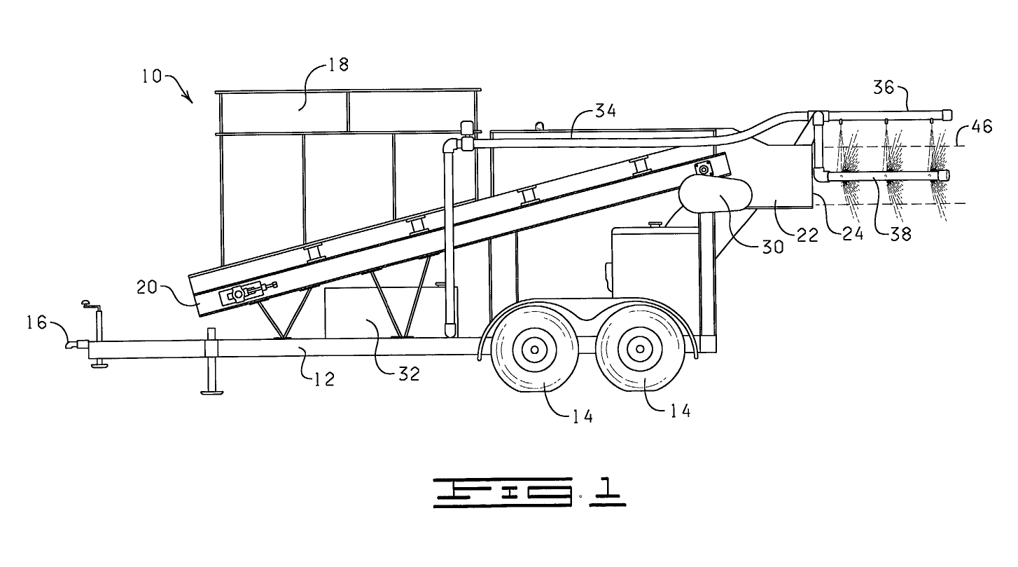

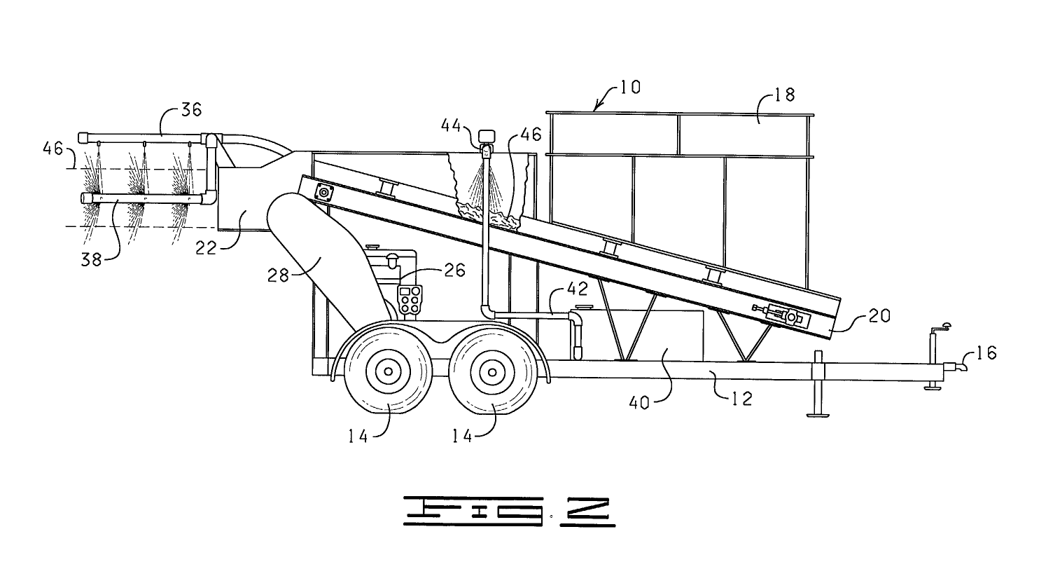

Referring to the drawings in detail, and particularly FIGS. 1 and 2, reference character 10 generally designates the mixer-shredder machine which basically comprises a frame 12 supported by a pair of wheels 14 at the rear end thereof and having a trailer hitch 16 on the forward end thereof by means of which the machine may be transported from one location to another.

The machine 10 includes one or more hoppers 18 and a conveyer 20 forming a live bottom for the hoppers 18. The conveyer 20 extends from underneath the hoppers 18 to a hammermill 22, whereby material deposited in the hoppers 18 is conveyed into the hammermill 22, wherein the material is homogenized and discharged out the end 24 of the hammermill 22. Hammermill 22 and conveyer 20 are driven by an engine 26 mounted on the frame 12 and connected to the hammermill by a chain drive 28 (FIG. 2) and from the hammermill to the conveyer 20 by a chain drive 30 as shown in FIG. 1.

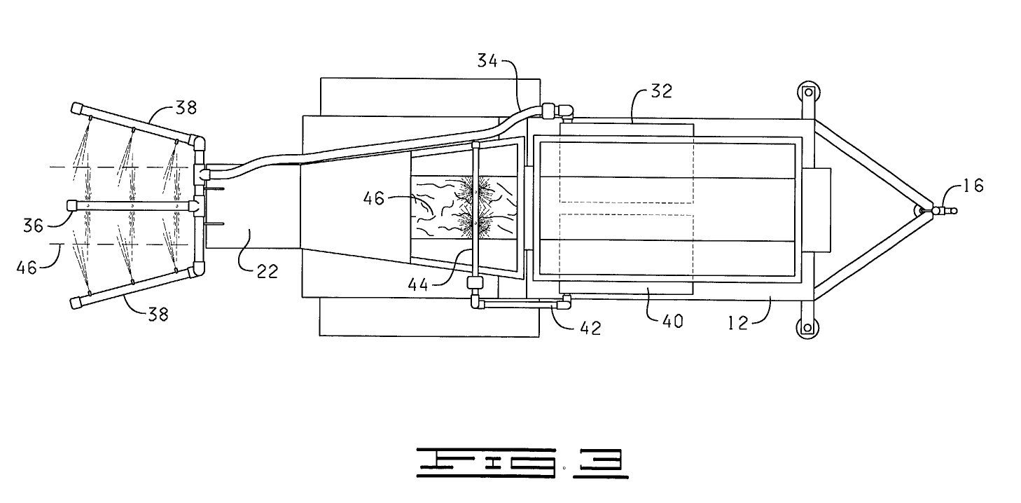

Pursuant to the present invention, the machine 10 is provided with a tank 32 mounted on the frame 12 and containing a pump (not shown) connected by piping 34 to spray bars 36 and 38 extending adjacent to the discharge end 24 of the hammermill 22. As shown by looking at FIGS. 1 and 3, the spray bar 36 extends above the path of movement of material discharging from the discharge end 24 of the hammermill 22 to spray material from the tank 32 onto the material being discharged from the hammermill; whereas the spray bars 38 extend along the sides of the path of movement of the material being discharged from the hammermill 22 to spray material from the tank 32 into the sides of that material being discharged from the hammermill. In this manner, the liquid from the tank 32 will be rather thoroughly mixed with the material being discharged from the hammermill 22. The liquid being pumped from the tank 32 to the spray bars 36 and 38 may be any chemical composition designed to reduce the particular contamination of the soil being discharged from the hammermill 22. For example, the chemical composition may be surfactants, ozone, chelators and encapsulation agents and biodegration enhancers including nutrients, microbial growth stimulators, and native microbial population.

As shown in FIGS. 2 and 3, another tank 40, containing a suitable pump (not shown) is mounted on the frame 12 and is connected by piping 42 to a spray bar 44 extending over the top of the conveyer 20 between the hoppers 18 and hammermill 22. The spray bar 44 is utilized to spray liquid on soil 46 being transported by the conveyer 20 from the hoppers 18 to the hammermill 22. The tank 40 may contain any desired liquid, such as water for moistening the soil 46 and/or, a suitable composition for treating the soil 46. In some cases, water in the tank 40 may be ozonated as it is being sprayed onto soil just before the soil is fed into the hammermill 22.

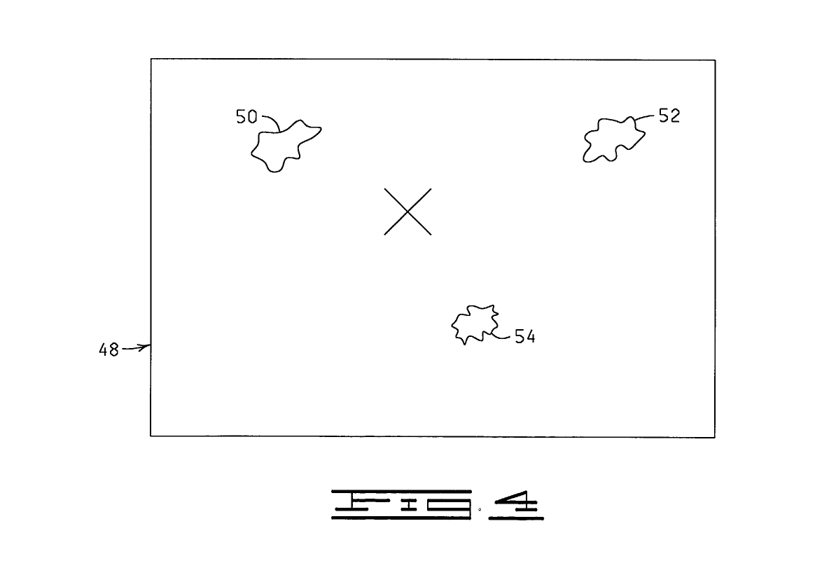

FIG. 4 is provided to illustrate a contaminated area 48 which may be, for example, 5 acres of contaminated soil wherein the level of contamination varies from location to location within the area 48. For example, as a result of a contamination survey, it may be determined that three locations 50, 52 and 54 are contaminated to a level above a predetermined amount. For example, the locations 50, 52 and 54 may be contaminated with hydrocarbon to levels exceeding 20,000 mg/kg total petroleum hydrocarbons (TPLt); whereas the remaining portion of the area 48 is contaminated to a lesser extent.

Pursuant to the present invention, the more highly contaminated soils in the locations 50, 52 and 54 are excavated and moved to a location X which may be on the area 48 or adjacent to the area 48. The soils from the locations 50, 52 and 54 are then mixed by use of a front end loader, for example, to obtain what may be considered a rather rough mixture of the soils.

The machine 10 would then be located at X and the grossly mixed soils from the areas 50, 52 and 54 would be repeatedly run through the machine 10 to homogenize these soils into a rather uniform level of contamination. In this use of the machine 10, the tank 40 would preferably contain water which is sprayed by the spray bar 44 onto the soil 46 being moved by the conveyer 20 in order to obtain a moisture content for the homogenized soils of, for example, 5%.

After the soil from the areas 50, 52 and 54 have been homogenized, then the remainder of the soil from the area 48 is in turn progressively moved through the machine 10 along with the soil from the areas 50, 52 and 54 to produce a homogenized soil having a relatively uniform level of contamination. When that level of contamination is achieved, then the soil may be repeatedly passed through the machine 10 and treated with the desired chemical compositions by spraying those compositions using the spray bars 36, 38 and 44. As previously mentioned, the chemical composition used for decontamination may be, for example mixtures of surfactants, chelalation and/or encapsulation agents, and biodegration enhancers, including nutrients microbial growth stimulation and native microbial population. Ozone treatment may also be used, depending upon the particular contamination and level of contamination. For example, if the contamination was a result of diesel oil the chemical composition may be surfactants and biodegradtion enhancers.

It should also be noted that the soil excavated from not only the highly contaminated areas 50, 52 and 54, but the remainder area 48 can be treated either on the area 48 or outside the area 48, depending upon the circumstances required.

After all of the soil from the area 48 has been decontaminated to the desired level, then the decontaminated soil will be spread back over the area 48, preferably to a uniform level.

After the decontaminated soil is spread back over the area 48, a layer of compost may be applied onto the decontaminated soil to a level of, for example 2 inches. Alternatively, the compost may be mixed with the decontaminated soil during passage of the soil through the machine 10.

Also, after the decontaminated soil has been redistributed over the area 48, the desired grass seeds may be distributed through the soil to provide an attractive reclaimed area. Further, if desired, earth worms may be distributed throughout the distributed soil to enhance the productivity of the soil.

The soil 46 will be discharged from the hammermill 22 in a more or less rectangular cross sectional pattern as illustrated in FIGS. 1, 2 and 3 before gravity takes over and the soil falls; whereby the sprays from the spray bars 36 and 38 will thoroughly coat the soil.

Changes may be made in the combination and arrangement of steps and procedures as set forth in the specification and shown in the drawings, without departed from the spirit and scope of the invention as defined in the following claims.

What is claimed is:

1. A method of treating contaminated soil, comprising the steps of:
a) determining the level of contamination at a plurality of locations in the area to be treated;
b) excavating the contaminated soil from the locations having a level of contamination higher than a predetermined level;
c) transporting the soil excavated in step b) to a pre-determined location on the area to be treated;
d) homogenizing soil collected by step c) into a substantially uniform level of contamination;
e) excavating the remaining contaminated soil in the area to be treated;
f) homogenizing the soil excavated by steps b) and e) into a substantially uniform level of contamination;
g) reducing the level of contamination of the soil resulting from step f) to an acceptable level; then
h) redistributing the soil resulting from step g) substantially uniformly over the area from which the soil was removed.

2. The method defined in claim 1, wherein compost is homogenized with the soil obtained in step g) prior to redistributing the soil as set forth in step h).

3. The method defined in claim 1, wherein a layer of compost is distributed over the soil redistributed as set forth in step h).

4. The method defined in claim 3 wherein the compost is distributed to a depth of approximately two inches.

5. The method defined in claim 1 wherein grass seeds are planted in the soil redistributed as set forth in step h).

6. The method defined in claim 2 wherein grass seeds are planted in the redistributed soil and compost.

7. The method defined in claim 3 wherein grass seeds are planted in the layer of compost.

8. The method defined in claim 1 wherein earth worms are planted in the redistributed soil.

9. The method defined in claim 2 wherein earth worms are planted in the redistributed soil and compost.

10. The method defined in claim 3 wherein earth worms are planted in the layer of compost.

11. A method of treating soils excavated from a plurality of locations and having varying levels of contamination, comprising the steps of:
a) mixing the soils obtained from the various locations to obtain a partial homogenization;
b) moistening the mixture obtained by step a), then
c) thoroughly homogenizing the soil mixture to a substantially uniform level of contamination.

12. The method defined in claim 11 wherein a contamination reducing agent is sprayed on the soils mixed pursuant to step a).

13. The method defined in claim 11 wherein a contamination reducing agent is sprayed on the homogenized soils leaving the homogenizing device.

14. The method defined in claim 12 wherein the contamination reducing agent is ozone.
